(19) United States
(12) Patent Application Publication
(10) Pub. No.: US 2016/0087502 A1
(43) Pub. Date: Mar. 24, 2016

(54) Systems and Methods for Splicing Electrical Conductors in an ESP Motor

(71) Applicant: Baker Hughes Incorporated, Houston, TX (US)

(72) Inventors: Michael R. Rumbaugh, Tulsa, OK (US); Jackson E. Reynolds, Catoosa, OK (US); Sean A. Cain, Owasso, OK (US)

(21) Appl. No.: 14/495,625

(22) Filed: Sep. 24, 2014

(51) Int. Cl. H02K 3/44; F04D 13/08; H02K 5/132; H02K 3/30; H02K 3/12

(52) U.S. Cl. CPC H02K 3/44; H02K 3/30; H02K 3/12; H02K 5/132; F04D 13/08

(57) ABSTRACT

Systems and methods for providing moisture-proof seals around the splices in an ESP motor. Two-layer encapsulation around each splice includes an outer layer of heat-shrink material that shrinks at a first temperature, and an inner layer of insulating material that melts at a temperature below the first temperature. The encapsulation materials are positioned around the electrical junction of the splice and heated. As the temperature reaches the melting temperature of the inner material, this material melts. As the temperature reaches the temperature at which the outer layer begins to shrink, the outer layer presses softened material of the inner layer against the conductors and the wire insulation near the splice, thereby conforming the material of the inner layer to the magnet wires at the splice and forming a moisture-proof barrier. Similarly constructed splices can connect motor lead extensions to the stator windings and form a Y-point of the motor.

### BACKGROUND

1. Field of the Invention

The invention relates generally to motors of electric submersible pumps (ESP's), and more particularly to systems and methods for providing insulation to electrically isolate splices between electrical conductors and to protect the spliced conductors from exposure to water and well fluids.

2. Related Art

Oil and natural gas are often produced by drilling wells into oil reservoirs and then pumping the oil and gas out of the reservoirs through the wells. If there is insufficient pressure in the well to force these fluids out of the well, it may be necessary to use an artificial lift system in order to extract the fluids from the reservoirs. A typical artificial lift system employs an ESP which is positioned in a producing zone of the well to pump the fluids out of the well.

An ESP system includes a pump and a motor which is coupled to the pump and drives the pump. The motor of the ESP system is typically an AC induction motor. The motor has a stator that is cylindrical with a coaxial bore, and a rotor is coaxially positioned within the stator bore. The rotor is coupled to a shaft so that rotation of the rotor turns the shaft. Bearings hold the rotor in position within the bore of the stator and allow the rotor to rotate within the bore.

In an AC induction motor, magnetic fields are generated in the stator and are induced into the rotor. The interaction of the magnetic fields created by the stator and the rotor cause the rotor to rotate within the stator. The magnetic fields are generated by electromagnets in the motor. These electromagnets are formed by positioning coils (windings) of insulated wire (magnet wire) around ferromagnetic cores. The core of the stator has “slots”, and the portions of the core between the slots form the cores of the electromagnets. When electric current is passed through the wire, magnetic fields are generated around the wire and consequently in the ferromagnetic cores. Changing the magnitude and direction of the current changes the magnitude and polarity of the magnetic fields generated by the electromagnets.

The wires that form the windings of the stator may be very long, and it is not unusual for segments of the wires to be spliced together. These splices are vulnerable to moisture, and exposure of the electrical conductors at the splices to moisture may cause arcing, short circuits, or corrosion of the conductors. These conditions may shorten the run life of the motor, or may cause the motor to fail. It is therefore important to protect the splices from moisture.

In a conventional ESP motor, the motor is filled with dielectric oil. The oil lubricates and cools the motor, and helps protect the motor components, including the spliced motor windings, from moisture. The motor is sealed to prevent water, well fluids and other contaminants from mixing with the oil and subsequently damaging the motor components. Since the oil expands and contracts as its temperature changes, a motor seal having a reservoir for the oil must be provided to accommodate the changing volume of the oil. The seal may, however, fail and allow moisture into the motor, so it would be desirable to provide improved means to protect the splices from this moisture.

### SUMMARY OF THE INVENTION

The embodiments of the present invention are therefore directed to providing moisture-proof seals around the splices themselves. This may be accomplished by using a two-layer encapsulation around each splice. An outer layer consists of a heat-shrink material that shrinks at a first temperature, while an inner layer consists of an insulating material that melts at a temperature below the first temperature. The two-layers of encapsulation material are positioned around the electrical junction of the splice and are heated. When the temperature of the materials nears the melting temperature of the inner material, this material begins to soften. As the temperature increases to the temperature at which the outer layer begins to shrink, this outer layer presses softened material of the inner layer against the conductors and the wire insulation near the splice. The softened material of the inner layer thereby conforms to the magnet wires at the splice and forms a moisture-proof barrier around the splice. This barrier protects the splice from moisture in the event of a motor seal failure, and may even allow the motor seal to be eliminated. The same type of moisture-proof barrier may be provided around splices between the windings of the stator and the motor lead extensions that couple the windings to the power cable at the exterior of the motor.

This disclosure is directed to systems and methods for protecting splices in ESP motors that solve one or more of the problems discussed above. One particular embodiment comprises a method for constructing an ESP. In this method, a plurality of magnet wire segments are provided. Two or more of these segments are spliced together to form a magnet wire that is long enough to form a winding for the stator. Splicing a pair of the magnet wire segments begins with preparation of the ends of the wire segments, including stripping the insulation from the ends of the wire segments and cleaning the conductors if necessary. Then, a two-layer tubular insulating structure is placed around one of the segments, and the conductors of the wire segments are joined to form a continuous electrical path through the wire segments. The tubular insulating structure is then positioned around the connected conductors. Preferably, the tubular structure overlaps the insulation of each wire segment. The tubular insulating structure is then heated to a temperature at which an inner layer of the tubular insulating structure melts and an outer layer of the tubular insulating structure shrinks. This causes the outer layer of the structure to squeeze the inner layer against the conductors and insulation of the wire segments, conforming the inner layer to the wire segments and sealing the electrical conductors so that they are not exposed to moisture and contaminants external to the splice. The tubular insulating structure is then cooled to solidify it. The resulting spliced magnet wire is then used to form a stator winding that is installed in a stator core. The stator windings may be wound and then installed on the core, or they may be wound on the core itself. The same process can be used to splice motor lead extensions to the stator windings, or to splice together the stator windings at the Y-point of the motor.

An alternative embodiment comprises an ESP that includes a motor and a pump. The motor has a stator in which the stator windings include one or more splices between magnet wire segments. The splices are formed between successive magnet wire segments. Each splice comprises a junction of the electrical conductors of the wire segments. This junction is surrounded by an inner layer of an electrically insulating material, and an outer layer of shrink-wrap material. The insulating material of the inner layer has a melting point which is less than a temperature at which the outer layer of shrink-wrap material contracts. The materials may be selected so that the melting point of the inner layer of insulating material is higher than the operating temperature of the ESP. Because the splices of the magnet wire are moisture proof, the ESP may in some embodiments eliminate the seal section that is conventionally installed between the motor and the pump, thereby allowing well fluids to enter the motor while it is operating.

Another alternative embodiment comprises a stator for an ESP motor. In this embodiment, the stator includes a stator core having a plurality of slots and a set of stator windings that are positioned in the slots. Each of the stator windings is formed by insulated magnet wires, at least one of which is spliced together from multiple wire segments. The splice comprises a junction of the electrical conductors of the wire segments, an inner layer of electrically insulating material surrounding the two electrical conductors, and a shrink-wrap material surrounding the electrically insulating material. The inner insulating material has a melting point which is less than a temperature at which the shrink-wrap material contracts. The splice is moisture-proof and prevents water exterior to the splice from reaching the electrical conductors interior to the splice. The electrically insulating material covers the junction of the electrical conductors and is conformed to the shape of the conductors. The electrically insulating material and/or shrink-wrap material may cover a portion of the insulation on each magnet wire segment, and the inner insulating material may be bonded to the wire insulation to seal the splice against moisture and contaminants. The stator windings may also be spliced to motor lead extensions in the same manner. The stator may also have the terminal ends of the stator windings spliced together in the same manner to form a Y-point.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating some of the primary components of an electric submersible pump system.

FIG. 2 is a diagram illustrating the structure of an exemplary motor suitable for use in an electric submersible pump system.

FIG. 3 is a diagram illustrating the wiring of a closed-slot stator core designed for use in an AC induction motor.

FIG. 4 is a partial cross-section of the stator core showing the turns of magnet wire installed in the slots.

FIG. 5 is a diagram illustrating the structure of a splice between two segments of magnet wire in an ESP motor winding in one embodiment.

FIG. 6 is a a flow diagram illustrating a method for construction of a splice in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims. Further, the drawings may not be to scale, and may exaggerate one or more components in order to facilitate an understanding of the various features described herein.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise motors of ESP's in which moisture-proof seals that utilize a two-layer tubular insulating structure are provided around splices between segments of magnet wire in a stator winding, splices between the stator windings and motor lead extensions, and/or junctions between the terminal ends of the stator windings at a Y-point of the motor.

Referring to FIG. 1, a diagram illustrating the components of an electric submersible pump system in one embodiment. In this embodiment, an electric submersible pump system is implemented in a well for producing oil, gas or other fluids. An electric submersible pump system 120 is coupled to the end of tubing string 150, and the electric submersible pump system and tubing string are lowered into the wellbore to position the pump in a producing portion of the well. A drive system (not shown) at the surface of the well provides power to the electric submersible pump system to drive the system's motor.

Electric submersible pump system 120 includes a pump section 121, a seal section 122, and a motor section 123. Electric submersible pump system 120 may include various other components which will not be described in detail here because they are well known in the art and are not important to a discussion of the invention. Motor section 123 is coupled by a shaft through seal section 122 to pump section 121. Motor section 123 rotates the shaft, thereby driving pump section 121, which pumps the oil or other fluid through the tubing string and out of the well.

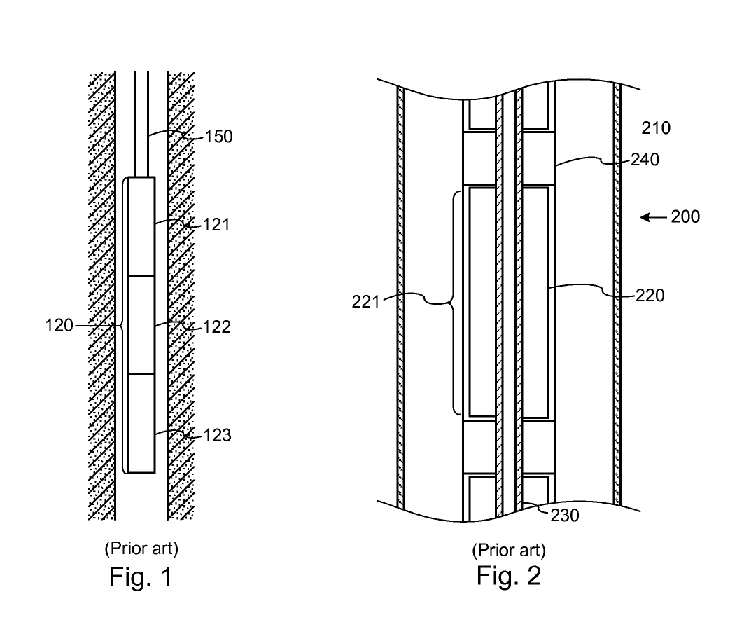

Referring to FIG. 2, a diagram illustrating the structure of an exemplary motor suitable for use in an electric submersible pump system is shown. As depicted in this figure, motor 200 has a stator 210 and a rotor 220. Stator 210 is generally cylindrical, with a coaxial bore that runs through it. Rotor 220 is coaxially positioned within the bore of stator 210. Rotor 220 is attached to a shaft 230 that is coaxial with the rotor and stator 210. In this example, rotor 220 includes multiple sections (e.g., 221), where bearings (e.g., 240) are positioned at the ends of each section. The bearings support shaft 230, and consequently rotor 220, within the bore of stator 210 and allow the rotor and shaft to rotate within the stator.

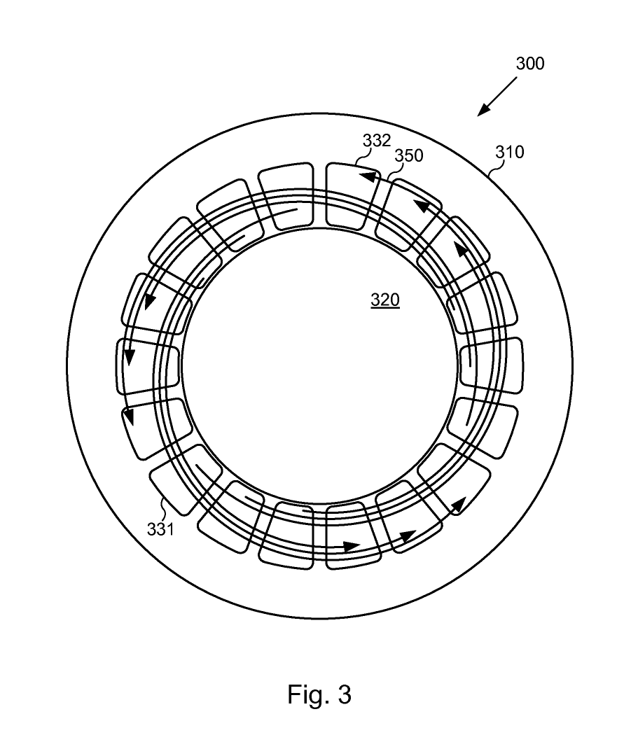

Referring to FIG. 3, a diagram illustrating the wiring of a closed-slot stator core designed for use in an AC induction motor is shown. Stator core 300 is generally annular, with a cylindrical outer portion 310 and a cylindrical bore 320 at its center. A plurality of passageways (e.g., 331 and 332) are formed in stator core 300. These passageways are often referred to as “slots” because they are sometimes open to the cylindrical space in the center of the stator. In this example, however, they are closed and form tubular passageways through the stator core.

The slots (e.g., 331 and 332) extend entirely through the stator core so that wires can be threaded through them. A wire is threaded through one slot and back through a different slot to form a turn of wire. The wire may be threaded through these same slots multiple times to form a coil. The walls between the slots, sometimes referred to as “teeth”, serve as ferromagnetic cores, so that when a wire is wrapped around one or more of them, and current is passed through the wire, an electromagnet is formed. Although a wire could be threaded through adjacent slots in the stator core, this typically is not the case with induction motors. Thus, for example, a wire may be threaded upward through slot 331, and then back through slot 332, as shown by arrow 350. This may be repeated to form multiple turns. The other arrows in the figure show how wires may be threaded through the other slots to form the remaining wire coils. The particular winding pattern shown in the example of FIG. 3 is a two-pole, concentric winding.

The wires that are threaded through the passageways in the stator core typically have copper conductors that have an outer layer of electrical insulation. This insulation is intended to electrically insulate each turn of wire from the others so that current will pass through each of the turns, rather than bypassing one or more turns of wire if a short-circuit is created by electrical contact between the wire of two or more turns.

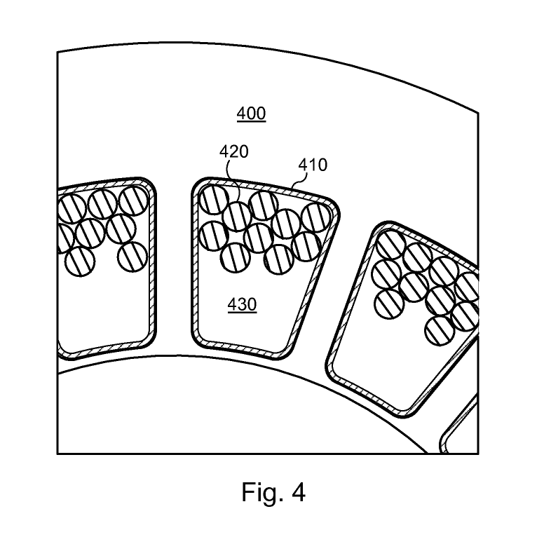

FIG. 4 is a partial cross-section of the stator core showing the turns of magnet wire installed in the slots. Commonly, an electrically insulating slot liner (e.g., 410) is placed in each slot (e.g., 430) of stator core 400, and the turns of magnet wire (e.g., 420) are threaded through the appropriate slots. In a closed slot design, the wires typically do not fill the entire volume of the slot because it becomes more difficult to thread the wires through the slots as the amount of space in the slots decreases (i.e., as the space is occupied by additional turns of magnet wire). An encapsulant or filler (not shown in the figure) may be introduced into the slots to prevent the wires from moving in the slots.

The ESP motor may be very long, and it may not be possible to create the desired number of turns in a winding with a single piece of magnet wire. It may therefore be necessary to splice together two or more segments of wire. These splices are protected by a two-layer insulating barrier. This barrier is formed by an inner layer of insulating material such as FEP (fluorinated ethylene propylene) and an outer layer of heat-shrink material such as PTFE (polytetrafluoroethylene). The inner layer has a melting point that is below the temperature at which the outer layer shrinks, so that, as the outer layer shrinks, it squeezes the softened inner layer against the magnet wires, thereby forming a moisture proof barrier around the splice.

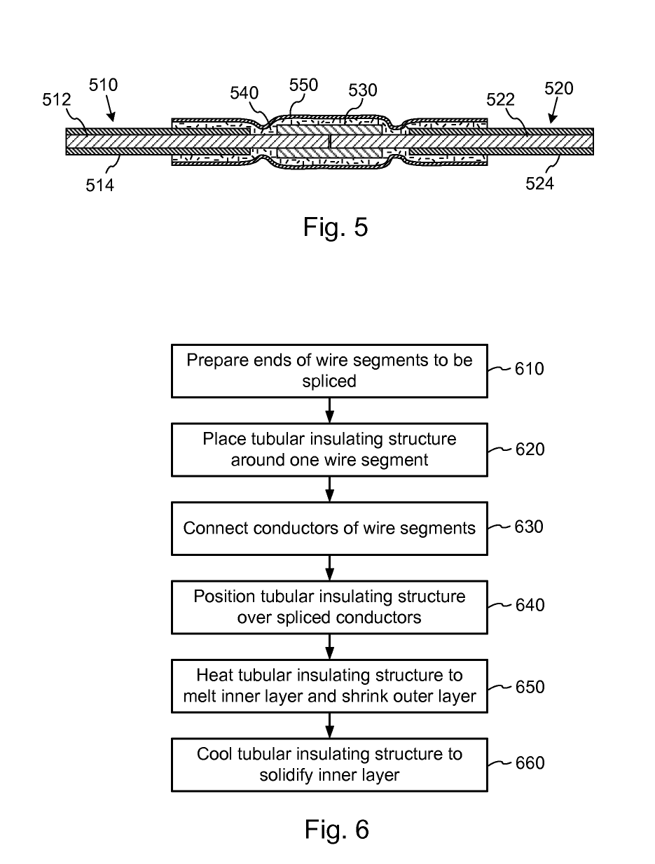

Referring to FIG. 5, a diagram illustrating the structure of a splice between two segments of magnet wire in an ESP motor winding is shown. In this example, the splice is made between two magnet wire segments (510, 520) that have identical structures. Each of the wire segments has a copper conductor (512, 522) that is covered by a layer of electrical insulation (514, 524). The insulation is stripped away from the ends of the conductors to allow the two conductors to be connected to each other. The conductors may be connected using any suitable means, such as twisting, soldering, crimping, etc., to produce a continuous electrical pathway through the wire segments. In FIG. 5, the conductors are depicted as being crimped within a conductive coupling 530.

The conductive components at the splice are surrounded by an inner layer (540) of a first insulating material and an outer layer (550) of a second insulating material. During installation of these insulating materials over the splice, they are heated to soften/melt the inner layer and cause the outer layer to shrink. The shrinkage of outer layer 550 squeezes inner layer 540, causing it to conform to the shape of the magnet wires and the conductive coupling. The insulating layers extend over the electrical insulation of each wire segment, sealing the splice and preventing moisture and contaminants from reaching conductors 512 and 522 and conductive coupling 550.

In one embodiment, inner layer 540 consists of FEP and outer layer 550 consists of PTFE. The inner and outer layers have a tubular shape prior to installation. After the conductors of the magnet wire segments are connected, this tube is positioned around the coupling and heated. The melting point of FEP is approximately 500 F (260 C), and the PTFE outer layer shrinks at approximately 620 F (327 C), so as the two-layer tubular structure is heated to 620 F, the inner layer melts, and then the outer PTFE layer shrinks, squeezing the inner FEP layer against the coupled magnet wires.

It should be noted that materials other than FEP and PTFE can be used in alternative embodiments. For example, the outer layer may use materials such as PFA (a perfluoroalkoxy copolymer resin made by DuPont), PEEK (polyether ether ketone), ECA (a perfluoroplastic resin made by DuPont) or other polymers. The inner layer may use various fluoropolymers or fluoropolymer blends. Because of the extremely high temperatures at which some ESP's operate, it may be desirable to use a combination of materials that have higher melting points and shrink temperatures than the FEP/PTFE combination described in the foregoing embodiments.

The construction of a splice as described above can be summarized as illustrated in FIG. 6. As shown in this figure, the ends of the two segments of magnet wire are first prepared (610). This may include, for example, stripping the electrical insulation from the ends of the wire segments. Before the electrical conductors of the wire segments are connected to each other, a tubular insulating structure is placed over one of the wire segments 620). The interior of the tubular structure is formed by the material (e.g., FEP) that will be the inner layer of insulation around the splice. The exterior of the tubular structure is formed by the shrinkable material (e.g., PTFE) that will be the outer layer of insulation around the splice.

The electrical conductors of the wire segments are connected to each other using conventional techniques (630). The tubular insulating structure is then positioned over the joined conductors (640). The ends of the tubular insulating structure overlap the magnet wire insulation on each of the wire segments so that the conductors will be completely covered. When the tubular insulating structure is in position, it is heated (650), causing the inner layer to melt, and then causing the outer layer to shrink onto the spliced magnet wires. As the tubular insulating structure shrinks, it will squeeze the inner layer onto the splice, conforming the material to the ends of the magnet wire segments. After the tubular insulating structure has been shrunk onto the splice, the material is allowed to cool and solidify (660). The spliced magnet wire can then be used to form a winding of the ESP stator.

It should be noted that the method of FIG. 6 is exemplary, and the splice may be made using methods that vary from the specific steps depicted in the flow diagram. Some of the steps may be performed in a different order, or alternative steps may be used to achieve similar results.

While the exemplary embodiments in the foregoing description involve splices in the magnet wire that is used to form the windings of the stator, there may be additional electrical junctions in the ESP motor that can be spliced in the same manner. For example, it is necessary to connect the wires of the stator windings to motor lead extensions that extend through the housing of the motor. These motor lead extensions are then connected to the power cable that provides power to drive the ESP motor. Also, ESP motors commonly have a “Y” (or “Wye”) configuration in which the terminal ends of the windings (the ends of the windings opposite the motor lead extensions) are electrically tied together. This junction is referred to as the Y-point (or Wye point). Both the splice to the motor lead extensions and the Y-point can be insulated and protected from moisture and contaminants in the same manner as the magnet wire splices described above.

As noted above, the techniques disclosed herein produce splices in an ESP motor that are moisture-proof. ESP motors using these splices are therefore protected from failures of the seal section which may allow water, well fluids and other contaminants to enter the motor housing. Another advantage is that, since the splices are protected from moisture and contaminants, it may not be necessary to include a seal section in the ESP to prevent contaminants (e.g., water) from entering the motor. Alternative embodiments of the invention may therefore include seal-less ESP's which are configured to purposely allow water or other well fluids to enter the motor. By eliminating the seal section of the ESP, the cost of the ESP may be reduced.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. An apparatus comprising:
a stator core having a plurality of slots therein; and
one or more stator windings positioned in the slots of the stator core;
wherein each of the stator windings is formed by one or more insulated magnet wires;
wherein at least one of the stator windings has a splice between two magnet wire segments;
wherein the splice comprises a junction of two electrical conductors, an inner layer of a first electrically insulating material surrounding the two electrical conductors, and a shrink-wrap material surrounding the first electrically insulating material; and
wherein the first insulating material has a melting point which is less than a temperature at which the shrink-wrap material contracts.

2. The apparatus of claim 1, wherein the splice is moisture-proof and prevents water exterior to the splice from reaching the two electrical conductors.

3. The apparatus of claim 2, wherein the first electrically insulating material covers the junction of the two electrical conductors and is conformed to a shape of the junction of the two electrical conductors.

4. The apparatus of claim 3, wherein the first electrically insulating material covers at least a portion of an insulation layer of each magnet wire segment adjacent to the junction.

5. The apparatus of claim 4, wherein the first electrically insulating material is bonded to the portion of the insulation layer of each magnet wire segment adjacent to the junction.

6. The apparatus of claim 1, wherein the apparatus further comprises one or more motor lead extensions, wherein each of the one or more motor lead extensions is spliced to a corresponding one of the stator windings, wherein the splice between the motor lead extension and the stator winding has the structure described in claim 1.

7. The apparatus of claim 1, wherein the apparatus further comprises a Y-point at which terminal ends of the stator windings are spliced to each other, wherein the splice between the stator windings has the structure described in claim 1.

8. An electric submersible pump (ESP) comprising:
a motor; and
a pump;
wherein the motor includes a stator having one or more stator windings,
wherein each of the stator windings is formed by one or more insulated magnet wires, and
wherein at least one of the stator windings has a splice between two magnet wire segments, wherein the splice comprises a junction of two electrical conductors and has an inner layer of a first electrically insulating material surrounding the two electrical conductors and a shrink-wrap material surrounding the first electrically insulating material, and wherein the first insulating material has a melting point which is less than a temperature at which the shrink-wrap material contracts.

9. The ESP of claim 8, wherein the ESP comprises a seal-less ESP that has no seal section coupled to the motor.

10. The ESP of claim 9, wherein the motor enables well fluids to enter the motor while the motor is in operation.

11. A method for constructing an electric submersible pump (ESP), the method comprising:
providing a stator core for an ESP motor, wherein the stator core has a plurality of slots therethrough;
providing a plurality of segments of magnet wire; and
for at least one pair of the magnet wire segments,
making a splice between the pair of the magnet wire segments, including electrically coupling conductors of the pair of magnet wire segments, positioning a two-layer tubular insulating structure around the electrical coupling,
heating the tubular insulating structure to a temperature at which an inner layer of the tubular insulating structure melts and an outer layer of the tubular insulating structure shrinks, thereby squeezing the inner layer against the electrical coupling, conforming the inner layer to the electrical coupling, and sealing the electrical coupling from moisture and contaminants external to the splice, and
cooling the tubular insulating structure, thereby solidifying the inner layer of the tubular insulating structure, and
installing the spliced segments of magnet wire in the stator core, thereby forming one or more stator windings in the stator core.

12. The method of claim 11, wherein positioning the two-layer tubular insulating structure around the electrical coupling comprises positioning the two-layer tubular insulating structure to extend over at least a portion of an insulation layer of each magnet wire segment adjacent to the electrically coupled conductors.

13. The method of claim 12, further comprising bonding the first electrically insulating material to the portion of the insulation layer of each magnet wire segment adjacent to the electrically coupled conductors.

14. The method of claim 11, further comprising splicing one or more motor lead extensions corresponding ones of the stator windings, wherein each splice between the motor lead extensions and the stator windings is formed as described in claim 11.

15. The method of claim 11, further comprising forming a Y-point at which terminal ends of the stator windings are spliced to each other, wherein the splice between the stator windings is formed as described in claim 11.

16. The method of claim 11, further comprising installing the stator core in an ESP motor.

17. The method of claim 16, wherein the motor is coupled to an ESP pump.

18. The method of claim 17, wherein the motor is coupled to the ESP pump without an intervening seal section, thereby enabling well fluids to enter the ESP motor.
